(19) United States
(12) Patent Application Publication
(10) Pub. No.: US 2003/0167688 A1
(43) Pub. Date: Sep. 11, 2003

(54) Plant root development container

(76) Inventors: Frederic P. Atchley, Apopka, FL (US); James Robin MacKay, Osteen, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/218,438

(22) Filed: Aug. 14, 2002

Related U.S. Application Data
(60) Provisional application No. 60/363,681, filed on Mar. 11, 2002.

(51) Int. Cl. A01G 23/02

(52) U.S. Cl. 47/73

(57) ABSTRACT

An apparatus for providing an improved root structure for a plant, the apparatus comprising a base, a plurality of vertical anti-circling channels connecting to the base and extending upwardly from the base, air channels formed in the base, a plurality of base anti-circling channels formed in the air channels extending along the length of the air channels, and ventilation holes in the base.

This application claims priority of Provisional Patent Application Serial No. 60/363,681, filed on Mar. 11, 2002.

### BACKGROUND OF THE INVENTION

This invention relates to a plant container, and more particularly, to an air root prune anti-circling container.

A plant is usually started from seed or cutting to begin the root formation process in a small container. After a period of time the plant is moved into the next size container to continue the development process. This step-up or moving the plant into the next size is accomplished primarily for the root development process than any other phase of growing. The root system is so important to the overall health of the plant that weak plants or plants that are not likely to grow into a specimen acceptable to the grades and standards acceptable for resale must be pulled and destroyed at a very early stage to minimize production losses.

A common problem in commercial ornamental horticultural nurseries is circling and kinking of the root system due to the plant having been left in the container too long. If a plant's root system extends outward too fast the roots will hit the container wall, which forces the roots to circle or follow the radius of the container. Root circling can cause the death of the plant within a short period of time. Likewise, a taproot, which grows downward, grows faster than the feed roots, which grow outward to the container walls. When a taproot reaches the base of a container it curves upward, thus forming a “J” root, which can kill a plant.

There are many products and prior art disclosures for solving the circling and “J” root problems, but have either been too expensive or too complicated to mold into an affordable container. Recently, new rules comprising grade and standards for classifying ornamental plants have been introduced. According to these rules, there can be no roots equal to ⅓ the diameter (caliper) of the plant, or tree or larger allowed to circle more than 30% of the container circumference.

An important thing to remember is that the roots are established early and do not change direction once they are established. With respect to a tree, roots generally grow out from the center of the tree and down to the depth of the environment. The more roots developed, the healthier the circulatory system and ability to uptake nutrients and moisture. The goal in growing the tree is to develop as many fibrous, hair-like roots as possible before the tree reaches a 1 to 2 inch caliper size. Additionally, the fibrous roots should be well branched and as straight as possible for a successful transplant into the next container size or a landscape project.

Currently available containers have no mechanism to stop root circling, “J” root formation, and provide air-root pruning. Air-root pruning is where a root encounters an opening built into the sidewall and or bottom of the container and is exposed to air. This exposure causes the root to harden or dry out at the tip. The drying in turn causes the root to divide off the main shoot wherever the soil is moist and the nutrients sufficient to support cellular division. A starchy build-up forms around the hardened root tip, which stops the flow of future nutrients. The more instances of this occurring during the formation of these tiny roots, the better from the standpoint of root mass and overall health. The branching may be singular or multiple depending on the species, ambient temperature, the nutrient/moisture ratio and the growing medium.

### BRIEF DESCRIPTION OF THE INVENTION

The present invention is directed to an apparatus and method for improving root development of a plant. In a preferred embodiment an apparatus is provided containing a base. A plurality of vertical anti-circling channels is connected to the base and extends upwardly from the base. An air channel is formed in the base. In a preferred embodiment, a plurality of air channels is formed. A plurality of base anti-circling channels is also formed in the base with ventilation holes formed through the base.

In another preferred embodiment a container has a sidewall comprised of a plurality of tiers where each descending tier has a smaller diameter than the tier immediately above. A base is connected to a bottom tier of the sidewall. A plurality of vertical anti-circling channels protrude from an inner surface of an inner surface of the sidewall, wherein each channel extends from the base upward a height of the sidewall. A plurality of slots is formed through the sidewall, and an air channel is formed in the base and elevated above an inner surface of the base. Likewise, a plurality of base anti-circling channels are formed in the air channel, and elevated above an inner surface of the air channel. Finally, a drainage hole is formed through the base.

A method for preventing circling of a plant's root and allowing air pruning provides for a container comprising a sidewall with a plurality of tiers where each descending tier has a smaller diameter than the tier immediately above, and a base connecting to the sidewall further comprising an air channel formed in the base. A root is prevented from circling with a plurality of anti-circling channels extending upward from an inner surface of the sidewall and across the base. A root is air-pruned with slots disposed though the sidewall of the container allowing air to enter the slots. Drainage holes are also provided in the base of the container.

### BRIEF DESCRIPTION OF THE DRAWINGS

The features of the invention are set forth with particularity in the appended claims. The invention itself, both as to organization and method of operation, may best be understood by reference to the following description in conjunction with the accompanying drawings in which like numbers represent like parts throughout the drawings and in which:

FIG. 1 is an exemplary embodiment of an elevational view of a preferred embodiment of the present invention;

FIG. 2 is an exemplary embodiment of a side view of a preferred embodiment of the present invention;

FIG. 3 is an exemplary embodiment of a bottom view of a preferred embodiment of the present invention;

FIG. 4 is an exemplary embodiment of a top view of a preferred embodiment of the present invention;

FIG. 5 is an exemplary embodiment of a top view of one preferred embodiment of the present invention;

FIG. 6 is an exemplary embodiment of a bottom view of one preferred embodiment of the present invention;

FIG. 7 is an exemplary embodiment of an elevational view of an skeletal basket that fits within a pre-existing container;

FIG. 8 is an exemplary embodiment of a cutaway side view of the skeletal basket within the pre-existing container; and

FIG. 9 is another exemplary embodiment of a cutaway side view of the skeletal basket within the pre-existing container.

### DETAILED DESCRIPTION OF THE INVENTION

With reference to the figures, exemplary embodiments of the invention will now be described. The scope of the invention disclosed is applicable to a plurality of containers used to grow plants, such as trees. Thus, even though embodiments are described specific to circular containers, one skilled in the art will recognize how the invention is also applicable to other shaped containers used for growing plants.

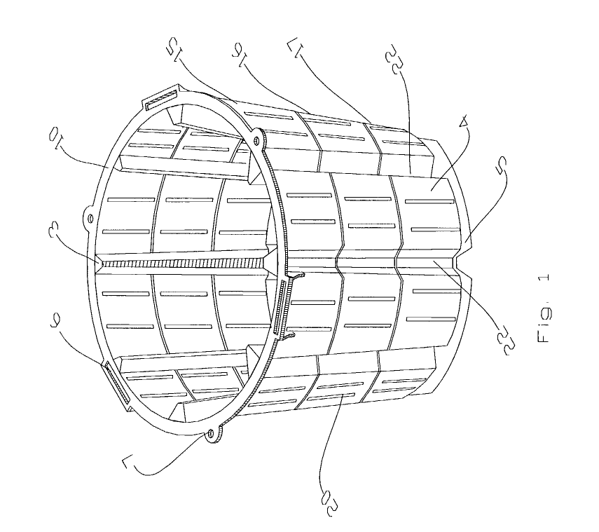

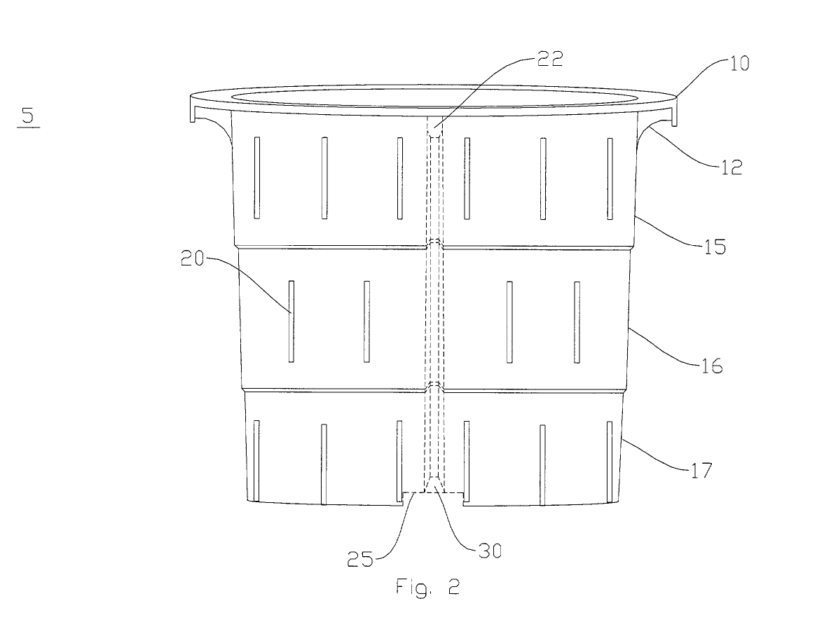

FIG. 1 is an exemplary embodiment of an elevational view of a preferred embodiment of the present invention and FIG. 2 is an exemplary embodiment of a side view of a preferred embodiment of the present invention. The plant container 5 has a top lip or rim 10, which, in a preferred embodiment, is reinforced with a plurality of gussets 12 placed around the underside of the top lip 10. In a preferred embodiment, the plant container 5 is comprised of three segments, or three tiers 15, 16, 17, which are offset with each descending tier being a smaller diameter than the tier immediately above. Thus where two tiers meet, an offset interior ledge is formed. The number of tiers is not limited to three. One tier may be used or any plurality of tiers may comprise a container 5. In a preferred embodiment, the invention is made out of injected molding, with UV stabilized resins for longer life.

Vertical slots, or air-root prune slots, openings, or holes 20, are formed, in a preferred embodiment, at equal distances, through the sidewall of each offset tier. The air-root pruning slots 20 are provided to allow air to enter and begin to harden the ends or tips of the roots, which then will cause the root to offshoot another root in another direction. More specifically, behind the hardened tips are a series of new hair-like roots, which begin to form branching at a right angle to the parent root and parallel to the container wall. In a preferred embodiment, the anti-root prune 20 slots are various sizes. For example, simply for illustration, in a three-tier container, the slots in the top tier 15 are ⅓ the size of the slots in the bottom tier 17, and the middle tier 16 is sized between the top 15 and bottom tier 17. In this configuration, since more air is reaching the roots in the bottom tier 17 when compared to the second 16 and first tier 15, this formation causes the root ball, or mass of roots, to hold more moisture higher in the root ball.

Sidewall anti-circling channels 22 are formed in a vertical direction through each tier 15, 16, 17 extending from the top tier 15 through any middle tier 16 down through the bottom tier 17. The tapered anti-circling channels 22 help to prevent the roots from circling around the inside wall of the generally cylindrically shaped container 5. When the root encounters a channel 22, it turns downward, which is desirable. Roots do not reverse direction towards the center, nor are they inclined to surface. As further illustrated in FIGS. 1 and 2, a raised air channel 25 is formed through the diameter of the base of the bottom tier 17. An anti-circling channel 30 is formed in the base air channel 25, where this base anti-circling channel 30 is in the same plane as a sidewall anti-circling channel 22 formed in the tiers 15, 16, 17. The sidewall anti-circling channels 22 also direct wind downward to the bottom of the container 5, and the base anti-circling channels 30 direct the wind towards the root ball, thus drying out the base of the ball.

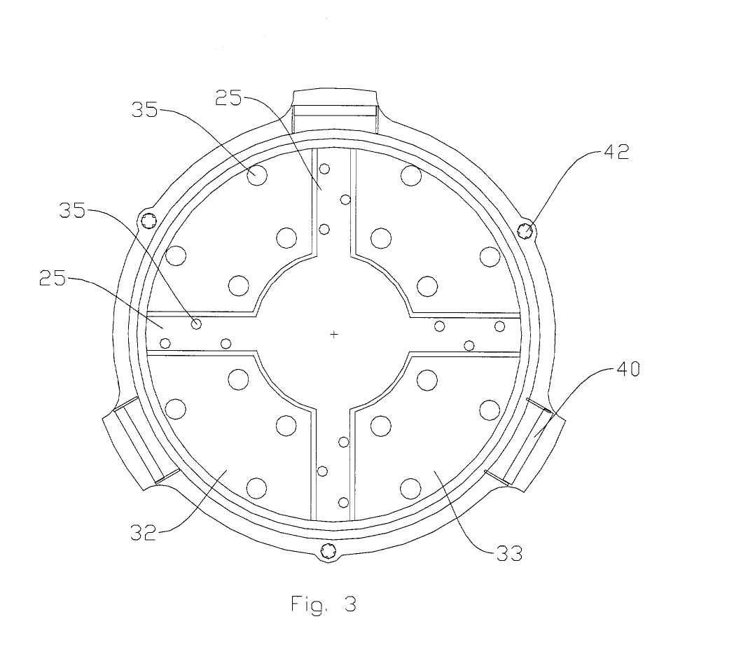

FIG. 3 is a bottom view of the present invention. As illustrated, recessed air channels 25 are displaced through the bottom, or base 32, of the container at a plurality of locations. In a preferred embodiment two air channels 25 are formed perpendicular to each other. The elevated and ventilated container bottom 32 serves to eliminate wet roots or pockets of standing water in the container 5. It also provides another mechanism to stop the “J” root formation of some species of plants. The container bottom 32 has two levels of drain openings 35 to provide a complete drying of the bottom area. The first level of drain openings 35 is in the elevated air channels 25 and the second level of drain openings are in the remaining area of the container bottom 33. Also disclosed in FIG. 3 are tie-down slots 40 and irrigation stake mounts 42.

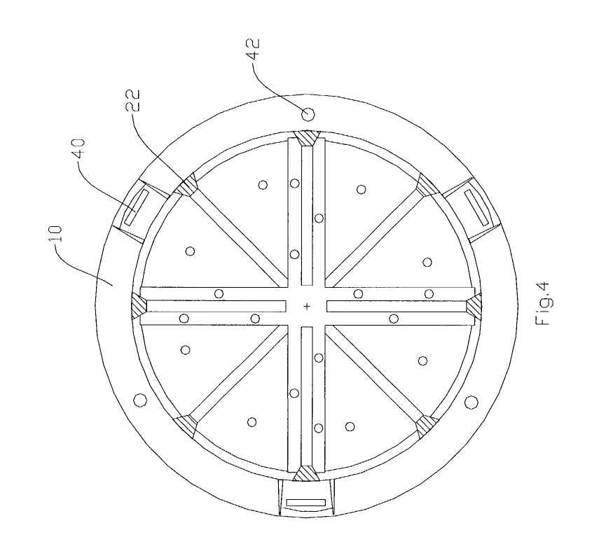

FIG. 4 illustrates a top view of the present invention. As illustrated, the upper lip 10 or ridge has tie-down slots 40 disposed through the upper lip 10 where in one embodiment there are three tie-down 40 slots disposed approximately 120° apart. Also disposed through the upper lip 10 are stake mounts 42, which, as disclosed in a preferred embodiment, are three, which are also approximately 120° apart. In a preferred embodiment, one or more of the stake mounts 42 are used as irrigation stake mounts. When used as an irrigation stake mount, the mount 42 is used to hold a micro-jet sprinkler and a thin wall tube for the purpose of providing moisture and nutrients to a plant at a predetermined rate. In another preferred embodiment, the irrigation stake mount 42 is used to hold a drip irrigation tube. The stake mounts 42 are also used to stake a container into the ground.

Sidewall anti-circling channels 22 are displaced at a plurality of locations around the inner circumference of the container, where in a preferred embodiment, they are spaced equally apart. As illustrated, in a preferred embodiment, there are eight sidewall anti-circling channels 22. Similarly, base anti-circling channels 30 are formed in the bottom or base 32 of the container where the sidewall anti-circling channels 22 connect with the base anti-circling channels 30. As one skilled in the art will recognize, the sidewall anti-circling channels 32 do not have to line up or meet with the base anti-circling channels 30. Additionally, the number of sidewall anti-circling channels 22 does not need to equal the number of base anti-circling channels 30.

As previously discussed, the base of the container 32 also contains elevated bottom air channels 25 and drainage holes 35 displaced through the base 32 and through the elevated bottom air channels 25. As illustrated, in a preferred embodiment, two elevated bottom air channels 25, running a diameter of the container 5, are disclosed perpendicular to each other. In the center of the air channels 25 are base anti-circling channels 30.

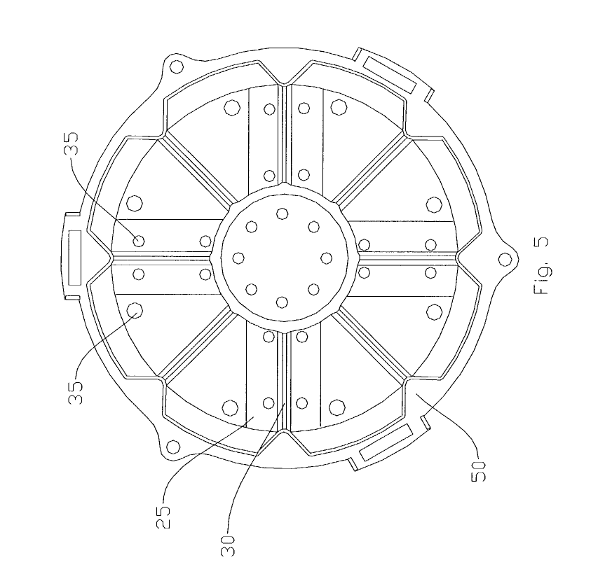

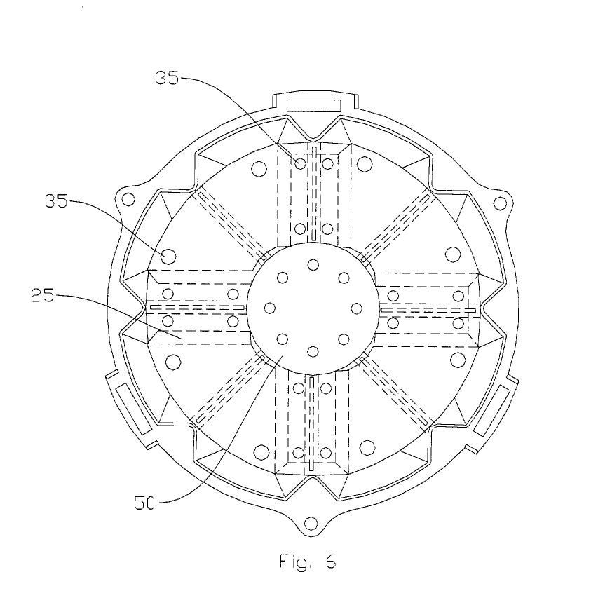

FIGS. 5 and 6 disclose a top view and bottom view, respectively, of another preferred embodiment of the present invention. As illustrated, an inner circular center 50 of the base is raised wherein the base air channels 25 and base anti-circling channels 30 end at the outer circumference of the inner circular center 50. Drainage holes 35 are dispersed through out the base 32, except through the inner circular center 50. As is further disclosed, a plurality of different sized drainage holes 35 may be placed in the base 32 and the base air channel 25.

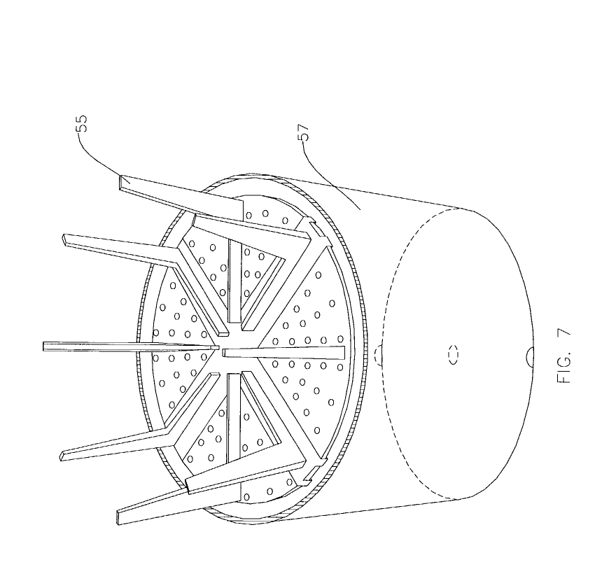

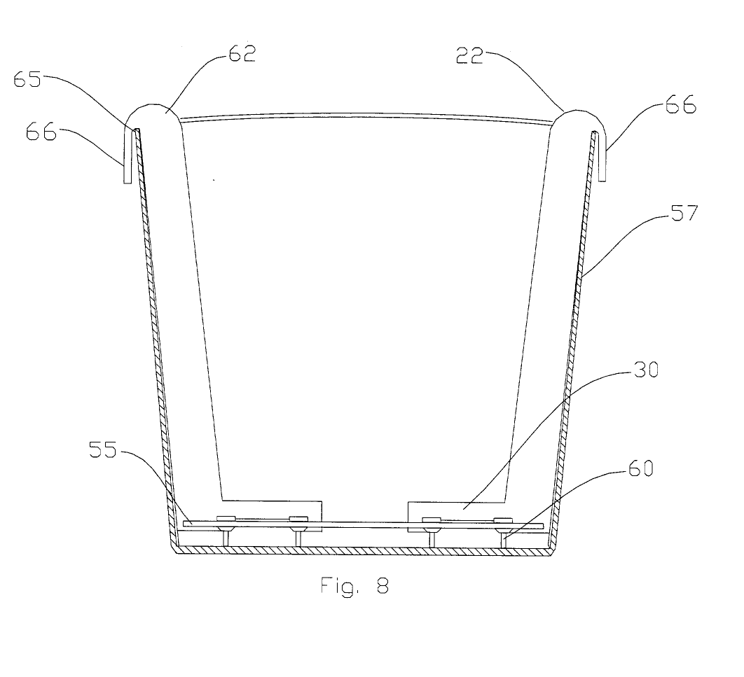

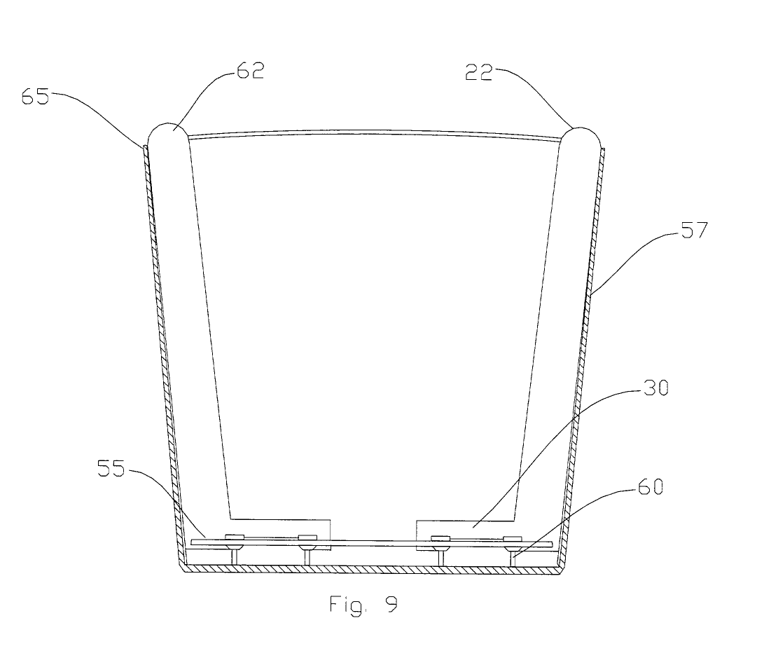

FIGS. 7, 8 and 9 are illustrations of the present invention disclosing a skeletal basket 55, which fits inside of a pre-existing container 57. The underside of the base of the skeletal basket 55 has legs, or supports 60, which allows for a gap between the skeletal basket 55 and the inner base of the container. Though not shown, where the sidewall anti-circling channels 22 meet or intersect with the base anti-circling channels 30, the two anti-circling channels 22, 30 are connected by a connector, or pivotal joint, allowing the sidewall anti-circling channels 22 to be positioned to fit against an inner circumference of a plurality of containers where each container has a unique side incline angle. To be the most effective, in one preferred embodiment illustrated in FIG. 9, the base of the skeletal basket 55 is close to the same diameter of the inner diameter of the container. In another preferred embodiment illustrated in FIG. 8, the upper ends 62 of the sidewall anti-circling channels have a hooking device 66, or another support device, allowing the channels to fit over the outer edge or lip 65 of the container 57. In this configuration the legs 60 are optional, since the hooking device will hold the skeletal basket 55 a specific distance from the inner base of the container 57.

In another preferred embodiment, not shown, an optional woven bag liner is also incorporated in the present invention to provide a simplified packaging method for a plant. The bag is inserted in the container 5 and the opening of the bag is flapped over the edge and down the sides of the present invention in a trash bag-like fashion. When the plant, or tree, has reached its mature size for that container, or is ready for sale, the overlapping bag is pulled upward above the top of the container, at which time a built-in drawstring is pulled until the bag is secured against the tree trunk. The drawstring is tied to the tree trunk and the tree is laid on its side. The container is pulled off the bag and relined for the next tree. The tree is now packaged for shipping where the landscape installer cuts the bag from the root ball and installs the tree, discarding the bag. In a preferred embodiment, the bag is made of a light-colored material to reflect harmful rays and to add to the life of the container. This disclosed woven bag can also be used with the skeletal basket 55.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

What is claimed is:

1. An apparatus for providing an improved root structure for a plant, the apparatus comprising:
(a) a base;
(b) a plurality of vertical anti-circling channels connecting to the base and extending upwardly from the base;
(c) an air channel formed in the base;
(d) a plurality of base anti-circling channels formed in the base; and
(e) ventilation holes formed therethrough the base.

2. The apparatus of claim 1 wherein the base fits within a container comprising a sidewall and a base wherein the sidewall has an upper lip.

3. The apparatus of claim 2 wherein the base further comprises legs extending downward creating a space between the base and an inner surface of the base of the container.

4. The apparatus of claim 2 wherein the plurality of vertical anti-circling channels and the base are connected by a connector wherein the anti-circling channels are adjustable to contact an inside surface of the container.

5. The apparatus of claim 2 wherein a hook extends from each anti-circling channel operable to connect the hook to the upper lip of the container.

6. The apparatus of claim 1 wherein the base anti-circling channels are formed in the air channels extending along the length of the air channels.

7. The apparatus of claim 1 wherein the base further comprises an elevated center wherein the air channel and base anti-circling channels end at the outer edge of the elevated center.

8. A plant growing apparatus, the apparatus comprising:
(a) a sidewall comprised of a plurality of tiers where each descending tier has a smaller diameter than the tier immediately above;
(b) a base connected to a bottom tier of the sidewall;
(c) a plurality of vertical anti-circling channels wherein each channel protrudes from an inner surface of the sidewall, extending from the base upward a height of the sidewall;
(d) a plurality of slots formed therethrough the sidewall;
(e) an air channel formed in the base and elevated above an inner surface of the base;
(f) a plurality of base anti-circling channels formed horizontally in the base and elevated above an inner surface of the air channel; and
(g) a drainage hole formed therethrough the base.

9. The apparatus of claim 8 further comprising a lip on a top tier.

10. The apparatus of claim 9 further comprising a tie-down slot disposed therethrough the lip.

11. The apparatus of claim 9 further comprising a stake mount disposed therethrough the lip.

12. The apparatus of claim 8 further comprising a bag liner wherein an opening in the bag liner fits over a lip of a top tier of the sidewall.

13. The apparatus of claim 12 wherein the liner comprises a drawstring.

14. The apparatus of claim 8 further comprising a raised center in the base.

15. The apparatus of claim 8 wherein a plurality of drainage holes are formed therethrough the base.

16. The apparatus of claim 8 wherein the plurality of slots is a plurality of sizes.

17. The apparatus of claim 16 wherein the slots increase in size in each lower tier of the sidewall.

18. The apparatus of claim 8 wherein one of the plurality of base anti-circling channels is formed in the air channel.

19. A method of air pruning and controlling root growth in a plant, the method comprising:
(a) providing a container comprising a sidewall with a plurality of tiers where each descending tier has a smaller diameter than the tier immediately above and a base connecting to the sidewall further comprising an air channel formed in the base;
(b) preventing a root from circling with a plurality of anti-circling channels extending upwardly along an inner surface of the sidewall and horizontally across the base;
(c) pruning a root with air entering through slots disposed therethrough the sidewall of the container; and
(d) providing drainage holes in the base.

20. The method of claim 19 further comprising securing a bag liner within the container.

21. The method of claim 20 further comprising extending an opening of the bag liner over an upper lip of the container.
